(19) United States
(12) Patent Application Publication
(10) Pub. No.: US 2010/0185657 A1
(43) Pub. Date: Jul. 22, 2010

(54) METHOD FOR SEARCHING DATABASE FOR RECORDED LOCATION DATA SET AND SYSTEM THEREOF

(76) Inventors: Chunyan Wang, Hefei (CN); Dao-Wen Deng, Hefei (CN)

Correspondence Address: NORTH AMERICA INTELLECTUAL PROPERTY CORPORATION, P.O. BOX 506, MERRIFIELD, VA, 22116, US

(21) Appl. No.: 12/403,385

(22) Filed: Mar. 13, 2009

(30) Foreign Application Priority Data
Jan. 12, 2009 (CN) 200910003424.2

(51) Int. Cl. G06F 17/30; G01C 21/00; G06Q 10/00

(52) U.S. Cl. 707/769; 701/200; 707/E17.018; 707/E17.108; 707/E17.001; 707/770

(57) ABSTRACT

A method for searching a database for at least a recorded location data set includes: (a) deciding at least one facility availability condition; (b) searching the database for at least a specific recorded location data set matching the facility availability condition; and (c) displaying the specific recorded location data set found in the database that matches the facility availability condition.

### BACKGROUND OF THE INVENTION

The present invention relates to a method for searching a database for a recorded location data set and a system thereof, and particularly relates to a method for searching a database in a navigator for POI and a system thereof.

Conventionally, a navigator has a database including a plurality of POIs (point of interest) stored therein, and a user can control the navigator to show desired POIs via inputting a location condition (for example: Beijing, Taipei, New York, etc.) or type descriptive information (for example: restaurant, theater). However, not all information according to this kind of search is relevant or useful. For example, if a user searches for a restaurant near his present location at 21:00 on a navigator, all nearby restaurants will be displayed. Some of the displayed restaurants may already be closed by 21:00 or may have no available seats, however. That is, some of the POIs may be unavailable, and a user must spend a lot of time to check if these POIs are useful or not.

### SUMMARY OF THE INVENTION

One embodiment of the present invention discloses a method for searching a database for at least a recorded location data set, comprising: (a) deciding at least one facility availability condition; (b) searching the database for at least a specific recorded location data set matching the facility availability condition; and (c) displaying the specific recorded location data set found in the database that matches the facility availability condition.

Another embodiment of the present invention discloses a data searching system, which comprises a database, an input interface, a control unit and a display device. The database is used for storing a plurality of recorded location data. The control unit is for receiving at least one facility availability condition from the input interface, and for searching the database for at least a specific recorded location data set matching the facility availability condition. The display device is for displaying the specific recorded location data set found in the database that matches the facility availability condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the operation according to a method for searching a database for at least a recorded location data set according to an embodiment of the present invention.

FIG. 2 is a schematic diagram illustrating an example for displaying searched POI according to a method for searching a database for at least a recorded location data set according to an embodiment of the present invention.

FIG. 3 is a flow chart illustrating detailed steps of a method for searching a database for at least a recorded location data set according to an embodiment of the present invention.

FIG. 4 is a flow chart illustrating detailed steps of a method for searching a database for at least a recorded location data set according to an embodiment of the present invention.

FIG. 5 is a block diagram illustrating a data searching system according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

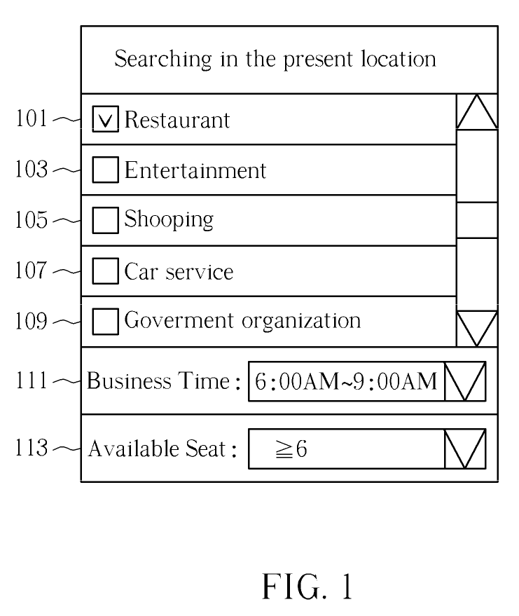

FIG. 1 is a schematic diagram illustrating the operation according to a method for searching a database for at least a recorded location data set according to an embodiment of the present invention. Specifically, FIG. 1 illustrates a user interface for a user to set a searching condition for searching POIs. A related art always provides fields 101, 103, 105, 107 and 109, such that a user can search POIs in the navigator according to the location or the condition type thereof. However, according to the above-mentioned description, such conditions cannot filter POIs that are not useful. Therefore, in this embodiment, the present invention further provides fields 111 and 113, such that a user can set a facility availability condition (FAC), which is business time condition and available seat condition in this case, via the fields 111 and 113. Via FAC, non useful POI can be filtered and the facilities (a store, a restaurant, or a theater) can be really used instead of just being displayed.

Take the embodiment shown in FIG. 1 for example, the field 111 indicates that the user wants to search POIs that can be used at 6:00 AM˜9:00 AM. Also, the field 113 indicates that the available seats of the POI must be larger than six. Thus, combining the conditions of fields 101, 111, 113, the restaurants having business time at 6:00-9:00 and more than 6 available seats are searched and displayed.

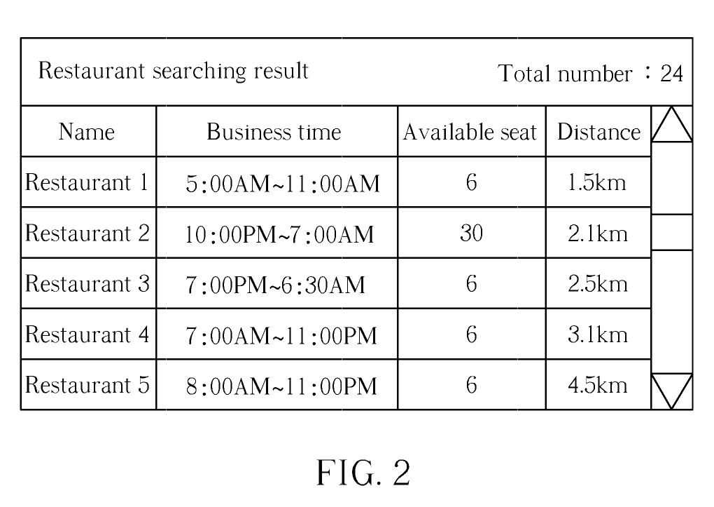

FIG. 2 is a schematic diagram illustrating an example for displaying a searched POI according to a method for searching a database for at least a recorded location data set according to an embodiment of the present invention. As shown in FIG. 2, the restaurants 1, 2, 3, 4 and 5 matching the business time condition and available seat condition determined in FIG. 1 are shown. Also, the data corresponding to the FAC determined in FIG. 1 (business time and available seat in this case) and the distance are also shown.

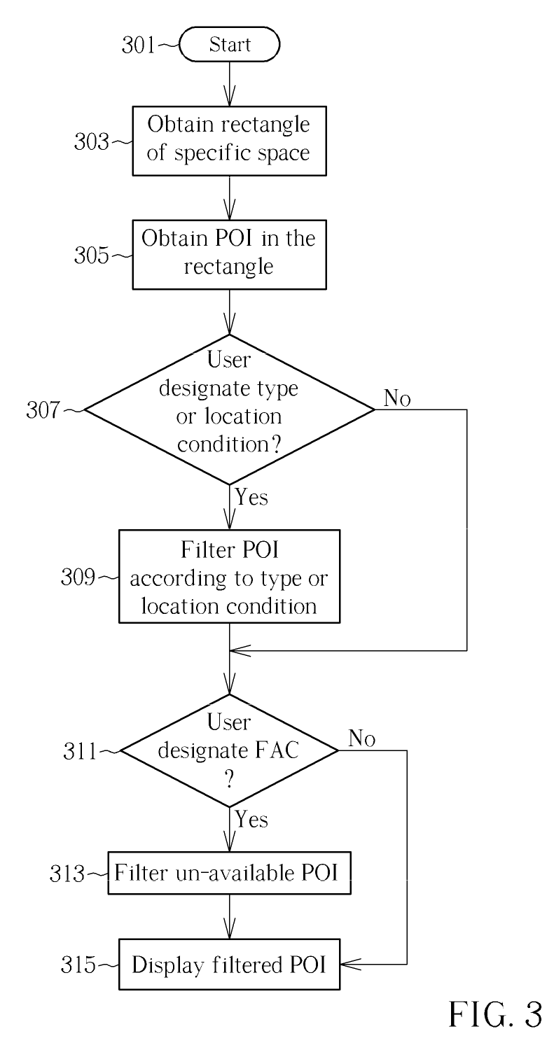

FIG. 3 is a flow chart illustrating detailed steps of a method for searching a database for at least a recorded location data set according to an embodiment of the present invention, where such steps are only one example and do not mean to limit the scope of the present invention. As shown in FIG. 3, the steps include:

Step 301: Start.

Step 303: Obtain a rectangle of specific space.

Step 305: Obtain POI in the rectangle.

Step 307: Does a user designate type or location condition? If yes, go to step 309. If not, go to step 311.

Step 309: Filter POI according to type or location condition.

Step 311: Does a user designate an FAC or not? If yes, go to step 313. If not, go to step 315.

Step 313: Filter un-available POIs according to the FAC.

Step 315: Display filtered POI.

The embodiment shown in FIG. 3 can further include the step of: determining at least a filtering condition such as a type condition and a location condition before determining the FAC. In this case, the POIs matching the FAC and the filtering condition are searched and displayed.

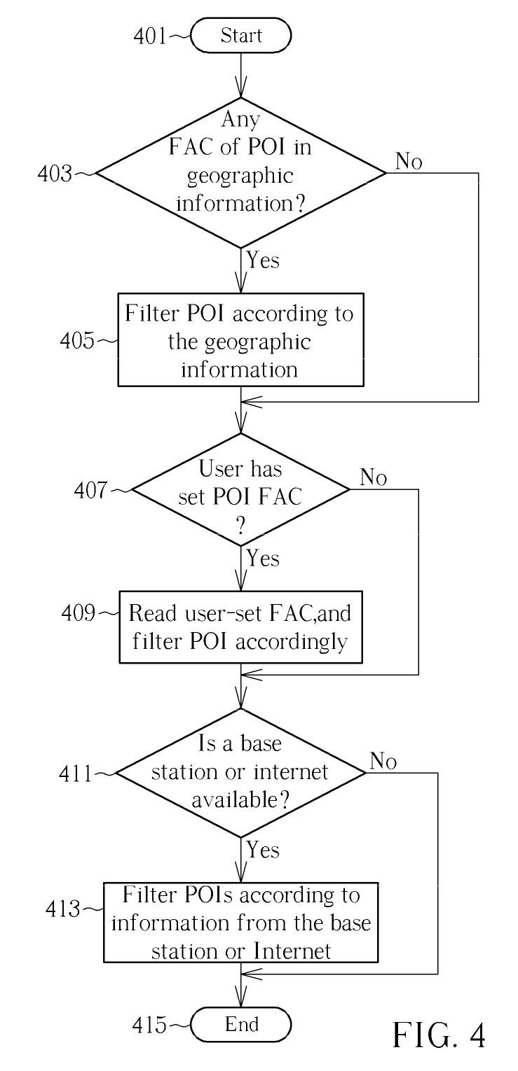

FIG. 4 is a flow chart illustrating detailed steps of a method for searching a database for at least a recorded location data set according to an embodiment of the present invention. Specifically, FIG. 4 explains the different sources of FAC. The steps include:

Step 401: Start.

Step 403: Is there any FAC of POI in geographic information that is pre-installed in a navigator? If yes, go to step 405. If not, go to step 407.

Step 405: Filter POI according to the geographic information.

Step 407: Does a user set a POI FAC via inputting user-setting data to the navigator? If yes, go to step 409. If not, go to step 411.

Step 409: Read POI FAC setting by the user and filter POIs accordingly.

Step 411: Is a base station or Internet available? That is, determine if there is any real time information of FAC. If yes, go to step 413. If not, go to step 415. It should be noted that the base station or Internet are only examples and do not mean to limit the scope of the present invention. The real time information can be from any other resource.

Step 413: Filter POIs according to information from the base station or Internet.

Step 415: End.

The order of the steps shown in FIG. 4 can be varied, thus the steps shown in FIG. 4 indicate that the FAC can be from at least one of: geographic information pre-installed in the navigator (steps 403, 405), user-setting data (steps 407, 409), and real time information (steps 411, 413).

According to the above-mentioned description, the method for searching a database for at least a recorded location can be summarized as follows: deciding at least one facility availability condition (FAC); searching the database for at least a specific recorded location data set matching the facility availability condition; and displaying the specific recorded location data set found in the database that matches the facility availability condition. Also, FAC is not limited to above-mentioned conditions. It can be other conditions such as a business time condition, goods providing condition, goods price condition, avoiding condition, and available seat condition. The avoiding condition indicates the locations that the user does not like or does not wish to go or pass through there, for example, a graveyard, a dirty place, or a place having chaotic traffic. Therefore if FAC has avoiding condition, the specific recorded location data near or located there will be filtered and will not be displayed. Also, the FAC can be from at least one of: geographic information pre-installed in the navigator, user-setting data, and real time information.

Besides, the method for searching a database for at least a recorded location can further include a step of recording user behavior, and the step of displaying the specific recorded location data set found in the database that matches the facility availability condition further displays the specific recorded location data according to the user behavior. For example, the utilization times of POI are recorded, and the step of displaying the specific recorded location data set found in the database that matches the facility availability condition displays the POI with most utilizing times first. Specifically, a user likes Japanese food and often goes to the Japanese food restaurant. Thus the method according to the present invention will record such example and the example shown in FIG. 2 will display the Japanese food restaurants at the upper location.

It should be noted that the method shown in FIG. 1˜FIG. 4 is not limited to be utilized in a navigator, and the POI can be other types of recorded location data.

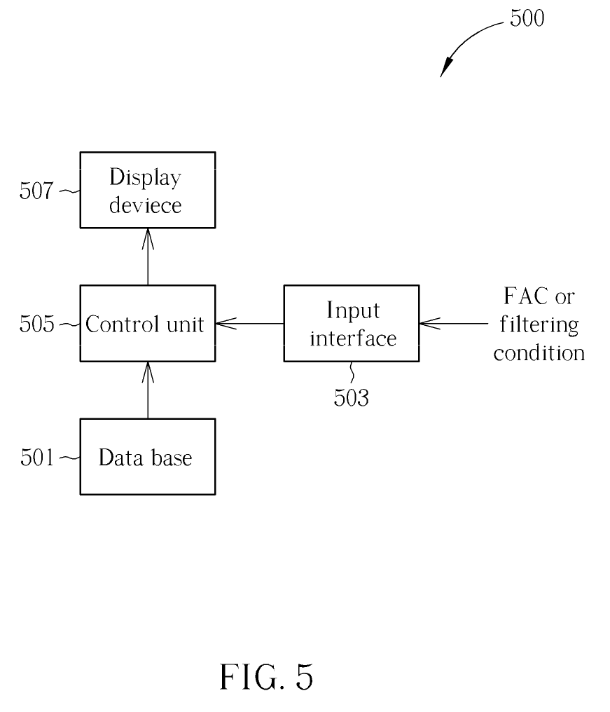

FIG. 5 is a block diagram illustrating a data searching system 500 according to an embodiment of the present invention. As shown in FIG. 5, the data searching system 500 includes a database 501 (for example, a storage device), an input interface 503, a control unit 505 and a display device 507. The database 501 is for storing a plurality of recorded location data sets. The control unit 505 is for receiving at least one FAC, or filtering condition, from the input interface 503, and for searching the database 501 for at least a specific recorded location data set matching the FAC or filtering condition. The display device 507 is for displaying the specific recorded location data set found in the database 501 that matches the FAC or filtering condition.

The data searching system 500 can be utilized for a navigator or any other electronic device. If the data searching system 500 is applied to a navigator, at least one of the database 501, the input interface 503, the control unit 505 and the display device 507 can be shared with the navigator. Since other detailed characteristics are already shown in FIG. 1˜FIG. 4, they are omitted here for brevity.

According to the above-mentioned embodiments, useful POIs can be searched effectively, such that useless POIs will not be displayed and the problem of the related art can be avoided.

Those skilled in the art will readily observe that numerous modifications and alterations of the device and method may be made while retaining the teachings of the invention.

What is claimed is:

1. A method for searching a database for at least a recoded location data set, comprising:
(a) determining at least one facility availability condition;
(b) searching the database for at least a specific recoded location data set matching the facility availability condition; and
(c) displaying the specific recoded location data set found in the database that matches the facility availability condition.

2. The method of claim 1, wherein the facility availability condition includes at least one of: open time condition, goods providing condition, goods price condition, avoiding condition, and available seat condition.

3. The method of claim 1, wherein the database is in a navigator.

4. The method of claim 3, wherein the recoded location data is POI (point of interest) data.

5. The method of claim 1, wherein the database includes preset geographic information stored therein.

6. The method of claim 1, wherein the database includes user data inputted thereto.

7. The method of claim 1, wherein the database includes real time information inputted thereto.

8. The method of claim 7, further comprising:
receiving the real time information from a base station or Internet, wherein the received real time information is stored into the database.

9. The method of claim 1, further comprising:
determining at least a filtering condition selected from a type condition and a location condition before the step (a);
wherein the step (b) searches the database for the specific recoded location data set matching the facility availability condition and the filtering condition.

10. The method of claim 1, wherein the step (c) displays information corresponding to the facility availability condition while displaying the recoded location data.

11. The method of claim 1, further comprising: recording user behavior, wherein the step (c) further displays the specific recoded location data set according to the recorded user behavior.

12. A data searching system, comprising:
a data base, for storing a plurality of recoded location data;
a input interface;
a control unit, coupled to the data base and the input interface, for receiving at least one facility availability condition from the input interface, and for searching the database for at least a specific recoded location data set matching the facility availability condition; and
a display device, coupled to the control unit, for displaying the specific recoded location data set found in the database that matches the facility availability condition.

13. The system of claim 12, wherein the facility availability condition includes at least one of: open time condition, goods providing condition, goods price condition, avoiding condition, and available seat condition.

14. The system of claim 12, being a navigator.

15. The system of claim 14, wherein the recoded location data is POI (point of interest) data.

16. The system of claim 12, wherein the database includes preset geographic information stored therein.

17. The system of claim 12, wherein the database includes user data inputted thereto.

18. The system of claim 12, wherein the database includes real time information inputted thereto.

19. The system of claim 18, wherein the control unit receives the real time information from a base station or Internet and stores the received real time into the database.

20. The system of claim 12, wherein at least a filtering condition selected from a type condition and a location condition is inputted to the control unit via the input interface before the facility availability condition is inputted;
wherein the control unit searches the database for the specific recoded location data set matching the facility availability condition and the filtering condition.

21. The system of claim 12, wherein the display device displays information corresponding to the facility availability condition while displaying the recoded location data.

22. The system of claim 12, wherein the control unit records user behavior, and the display device displays the specific recoded location data set according to the user behavior.
